(19) United States
(12) Patent Application Publication
(10) Pub. No.: US 2007/0217293 A1
(43) Pub. Date: Sep. 20, 2007

(54) Decorative product and timepiece

(75) Inventor: Koki Takasawa, Shimosuwa-machi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/716,655

(22) Filed: Mar. 12, 2007

(30) Foreign Application Priority Data
Mar. 17, 2006 (JP) JP 2006-075673

(51) Int. Cl. G04B 37/00

(52) U.S. Cl. 368/280; 428/682

(57) ABSTRACT

A decorative product having a base member composed of primarily an Fe—Cr alloy, and an austenite layer that is austenitized by adding nitrogen atoms near the surface of the base member.

### CROSS-REFERENCE TO RELATED APPLICATIONS

This application claims priority to Japanese Patent Application No. 2006-075673. The entire disclosure of Japanese Patent Application No. 2007-075673 is hereby incorporated herein by reference.

### BACKGROUND OF THE INVENTION

1. Technical Field

The present invention relates to a decorative product and to a timepiece. More specifically, the present invention relates to a decorative product and a timepiece having the product.

2. Related Art

Decorative products such as timepiece cases generally require an aesthetically attractive appearance. Metals with a silver color such as Pd, Rd, and Pt have typically been used to manufacture such decorative products in order to achieve the desired appearance. However, all of these metals are precious metals, and therefore increase the production cost of the decorative goods. Ti and stainless steel can be used as silver-colored materials instead of using such precious metals.

While an attractive appearance is essential for such decorative products, the surface of goods manufactured from such precious metals (particularly timepiece cases and jewelry) is easily scratched and the appearance can deteriorate significantly over a long period of time.

Japanese Laid-Open Patent Application Publication No. JP-A-9-31505 describes a method of manufacturing external parts for timepieces by mixing a ferritic stainless steel alloy powder with an organic binder, injection molding the mixture, and then degreasing and sintering the molding. However, producing external timepiece parts with a sufficiently attractive appearance with this method is difficult. The external timepiece parts obtained by this method are also lacking in sufficient hardness, and can be easily scratched and damaged when a comparatively strong external force is applied.

### SUMMARY OF THE INVENTION

The present invention provides a decorative product that maintains excellent hardness and an attractive appearance over a long period of time, and further provides a timepiece having this decorative product (member).

A decorative product according to a first aspect of the present invention has a base member primarily composed of an Fe—Cr alloy, and an austenite layer that is austenitized by adding nitrogen atoms near the surface of the base member. This aspect of the present invention affords a decorative product that can retain outstanding hardness and an attractive appearance for a long period of time.

A decorative product according to a second aspect of the present invention is preferably the product of the first aspect, wherein the thickness of the austenite layer is 5 μm to 500 μm. This aspect affords a particularly attractive appearance and durability in the decorative product.

A decorative product according to a third aspect of the present invention is preferably the product of the second aspect, wherein the thickness of the austenite layer is 150 μm to 350 μm. This aspect further affords a particularly attractive appearance and durability in the decorative product.

A decorative product according to a fourth aspect of the present invention is preferably the product of the first aspect, wherein the nitrogen content in the austenite layer is 0.3 wt % to 1.2 wt %. This aspect affords a particularly attractive appearance and durability in the decorative product.

A decorative product according to a fifth aspect of the present invention is preferably the product of the fourth aspect, wherein the nitrogen content in the austenite layer is 0.8 wt % to 1.2 wt %. This aspect further affords a particularly attractive appearance and durability in the decorative product.

A decorative product according to a seventh aspect of the present invention is preferably the product of the sixth aspect, wherein the Ni content in the base member is less than or equal to 0.05 wt %. This aspect further affords a decorative product with excellent magnetic shielding that can more reliably prevent the timepiece movement from being adversely affected by external magnetic fields when the decorative product is used as an external case member for a timepiece. This arrangement further and more effectively prevents metal allergies from developing in a user.

A decorative product according to an eighth aspect of the present invention is preferably the product of the first aspect, wherein the base member is further made from the group made of Mo, Nb, Mn, Si, Zr, and Ti.

A decorative product according to a ninth aspect of the present invention is preferably the product of the first aspect, wherein the austenite layer has a Vickers hardness Hv of 350 or more.

A decorative product according to a tenth aspect of the present invention is preferably the product of the ninth aspect, wherein the austenite layer has a Vickers hardness Hv of 400 or more.

The decorative product of any of the aforementioned aspects of the present invention is more preferably used as an external part of a timepiece.

The external parts of timepieces are generally decorative components that are easily subject to external impact and require both an attractive appearance as a decorative product as well as durability, corrosion resistance, mar resistance, and wear resistance for practical use, and the present invention enables meeting these conditions. Thus, another aspect of the present invention is a timepiece having the decorative product of the present invention.

The present invention thus also affords a timepiece that can retain outstanding hardness and an attractive appearance for a long period of time. The present invention provides a decorative product that can retain outstanding hardness and attractive appearance for a long period of time, and provides a timepiece having this decorative product.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross-sectional view schematically showing a decorative product (member) according to a preferred embodiment of the present invention;

FIGS. 2A and 2B are cross-sectional views schematically illustrating a method of manufacturing the decorative product according to the preferred embodiment of the present invention;

FIG. 3 is a partial cross-sectional view schematically illustrating of a timepiece (portable timepiece) according to the preferred embodiment the present invention; and

FIG. 4 is a plan view of the timepiece that has the decorative product.

### DESCRIPTION OF EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Decorative Product (Member)

A preferred embodiment of the present invention of a decorative product according to the present invention is described first below.

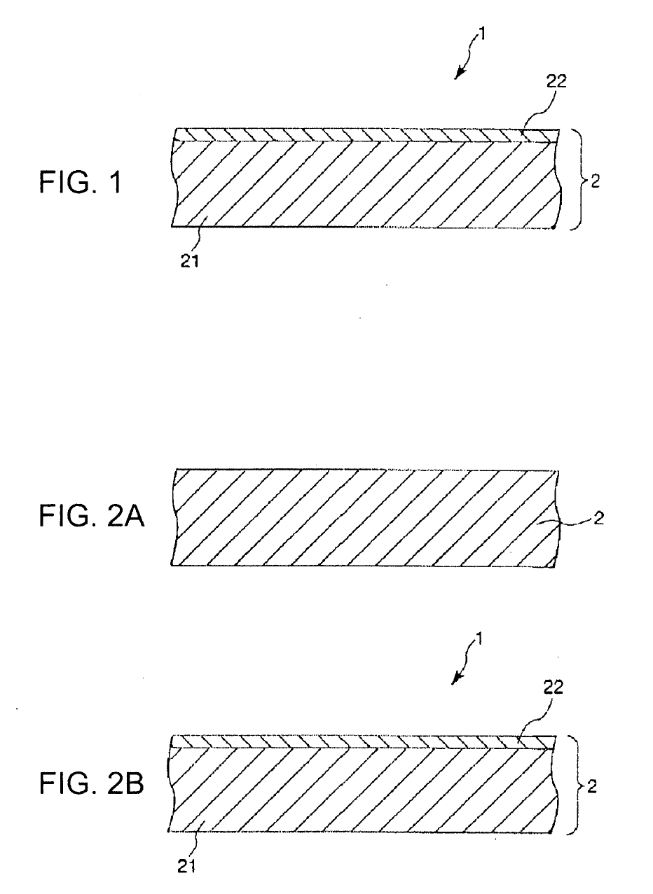

FIG. 1 is a cross-sectional view schematically showing a decorative product (member) according to a preferred embodiment of the present invention.

This decorative product 1 has a base layer 2 made primarily from an Fe—Cr alloy. The base layer 2 has a base portion 21 and an austenite layer 22. The austenite layer 22 is austenitized by adding nitrogen atoms near the surface of the base layer 2.

The base portion 21 (the base member 2 used to manufacture the decorative product 1) is made from an Fe—Cr alloy and is primarily a ferrite phase. This assures excellent moldability to mold the base layer 2 and enables forming an austenite layer 22 described in detail below that offers an excellent appearance, high hardness, excellent mar resistance (resistance to scratching), dent resistance (resistance to denting), and, corrosion resistance. This enables even complexly shaped decorative products such as ones used in the external parts of a timepiece to be molded in a desired shape and retains good hardness and an excellent appearance for a long period of time. Furthermore, Fe—Cr alloy generally provides excellent magnetic shielding so that when the decorative product is used as an external part of a timepiece, the decorative product reliably prevents the timepiece movement from being adversely affected by external magnetic fields.

The Fe—Cr alloy used in the base layer 2 can be any alloy containing Fe and Cr, but preferably meets the following conditions.

The Cr content of the Fe—Cr alloy including the base layer 2 (base portion 21) is preferably 15 wt % to 25 wt %, and is more preferably 17 wt % to 22 wt %. If the Cr content is within the range, good corrosion resistance, magnetic resistance, processability, and good appearance can be achieved. If the Cr content is below the lower limit of the range, the corrosion resistance of the decorative product 1 may be insufficient. If the Cr content exceeds the upper limit of the range, magnetic shielding will be insufficient and it may be difficult to prevent sufficiently the timepiece movement from being adversely affected by external magnetic fields when the decorative product 1 is used as an external part of a timepiece.

The Fe—Cr alloy including the base layer 2 can include constituents (elements) other than Fe and Cr. This inclusion can enable imparting the unique effects afforded by the included constituent (element). Examples of such constituents (elements) preferably include Mo, Nb, Mn, Si, Zr, and Ti.

If the Fe—Cr alloy including the base layer 2 contains Mo, for example, nitrogen atoms can be efficiently introduced near the surface of the base layer 2 (such as by diffusion to the grain boundary) and the decorative product 1 can be imparted with excellent corrosion resistance. The Mo content of the Fe—Cr alloy including the base layer 2 (base portion 21) is preferably 1.0 wt % to 4.0 wt %, and is more preferably 1.5 wt % to 3.5 wt %. If the Mo content is within the range, the decorative product 1 can be given a particularly attractive appearance, nitrogen atoms can be efficiently introduced near the surface of the base layer 2 (such as by diffusion to the grain boundary) when the austenite layer 22 is formed, and the decorative product 1 can be imparted with excellent corrosion resistance. If the Mo content is below the lower limit of the range, it may be difficult to achieve sufficient corrosion resistance in the decorative product 1 depending on the content of other constituents. In addition, if the Mo content is below the lower limit of the range, it may be difficult to implant efficiently nitrogen atoms near the surface of the base layer 2 (such as by diffusion to the grain boundary) when the austenite layer 22 is formed. Furthermore, if the Mo content exceeds the upper limit of the range, the structure of the austenite layer 22 will be particularly heterogeneous, deposits of Fe, Cr, and Mo can be separated, and the aesthetic appearance of the decorative product 1 may be impaired.

If the Fe—Cr alloy including the base layer 2 contains Nb, for example, the hardness of the decorative product 1 (austenite layer 22) can be improved and the decorative product 1 (austenite layer 22) can be imparted with particularly good mar resistance and dent resistance. The Nb content of the Fe—Cr alloy including the base layer 2 (base portion 21) is preferably 0.08 wt % to 0.28 wt %, and more preferably is 0.10 wt % to 0.25 wt %. If the Nb content is within the range, the decorative product 1 can be rendered with a particularly attractive appearance as well as outstanding durability (mar resistance and dent resistance). If the Nb content is below the lower limit of the range, the benefits afforded by Nb may not be sufficiently achieved. If the Nb content exceeds the upper limit of the range, the corrosion resistance of the decorative product 1 may drop.

The Fe—Cr alloy including the base layer 2 preferably contains no Ni or as little as possible. This enables efficient implanting of nitrogen atoms near the surface of the base layer 2 (such as by diffusion to the grain boundary) when the austenite layer 22 is formed, and imparts the decorative product 1 with excellent corrosion resistance and durability. This also provides the decorative product 1 with excellent magnetic shielding so that the decorative product reliably prevents the timepiece movement from being adversely affected by external magnetic fields when the decorative product is used as an external part of a timepiece. This can also effectively prevent development of a metal allergy in the user. The Ni content in the Fe—Cr alloy including the base layer 2 (base portion 21) is preferably less than or equal to 0.05 wt %, and is more preferably less than or equal to 0.01 wt %. Rendering the Ni content in the range makes these effects particularly pronounced.

The Fe—Cr alloy including the base layer 2 preferably contains no C or as little as possible. This feature more effectively minimizes the drop in corrosion resistance during molding. The C content in the Fe—Cr alloy including the base layer 2 (base portion 21) is preferably less than or equal to 0.02 wt %, and is more preferably less than or equal to 0.01 wt %. Rendering the C content in the range makes this effect particularly pronounced.

The Fe—Cr alloy including the base layer 2 preferably contains no S or as little as possible. This enables imparting the decorative product 1 with particularly good corrosion resistance. The S content in the Fe—Cr alloy including the base layer 2 (base portion 21) is preferably less than or equal to 0.02 wt %, and is more preferably less than or equal to 0.01 wt %. Rendering the S content in the range makes this effect particularly pronounced.

The Fe—Cr alloy including the base layer 2 preferably contains no P or as little as possible. This enables imparting the decorative product 1 with particularly good corrosion resistance. The P content in the Fe—Cr alloy including the base layer 2 (base portion 21) is preferably less than or equal to 0.07 wt %, and is more preferably less than or equal to 0.05 wt %. Rendering the P content in this range particularly pronounces this effect.

An austenite layer 22 that is austenitized by adding nitrogen atoms near the surface of the base layer 2 is thus provided.

This austenite layer 22 provides the decorative product 1 with excellent hardness as well as outstanding mar resistance (resistance to scratches) and dent resistance (resistance to denting).

Furthermore, because the base layer 2 is primarily composed of the Fe—Cr alloy and has the austenite layer 22, the decorative product 1 offers a particularly attractive appearance, high hardness, and excellent mar resistance, dent resistance, and corrosion resistance. The decorative product 1 is therefore extremely durable and can retain a particularly attractive appearance for a long period of time.

The thickness of the austenite layer 22 is not necessarily limited but is preferably 5 μm to 500 μm and more preferably is 150 μm to 350 μm. If the thickness of the austenite layer 22 is within the range, the decorative product 1 can be imparted with a particularly attractive appearance and excellent durability. If the thickness of the austenite layer 22 is below the lower limit of the range, it may be difficult to render the decorative product 1 with sufficient hardness and durability (mar resistance, dent resistance, corrosion resistance) depending on the nitrogen content in the austenite layer 22. If the thickness of the austenite layer 22 exceeds the upper limit of the range and the decorative product is used as an external component of a timepiece, it may be difficult to protect sufficiently the timepiece movement from the effects of external magnetic fields depending on the nitrogen content in the austenite layer 22. Furthermore, if the thickness of the austenite layer 22 exceeds the upper limit of the range, controlling the total nitrogen content becomes difficult depending on the nitrogen content in the austenite layer 22, and either a long time or costly equipment is required to implant nitrogen.

The nitrogen content in the austenite layer 22 is preferably 0.3 wt % to 1.2 wt %, and is more preferably 0.8 wt % to 1.2 wt %. If the nitrogen content is within the range, the decorative product 1 can be imparted with a particularly attractive appearance and excellent durability. If the nitrogen content of the austenite layer 22 is below the lower limit of the range, it may be difficult to render the decorative product 1 with sufficient hardness and durability (mar resistance, dent resistance, corrosion resistance) depending on the thickness of the austenite layer 22. If the nitrogen content of the austenite layer 22 exceeds the upper limit of the range, controlling the total nitrogen content becomes difficult depending on the thickness of the austenite layer 22, and either a long time or costly equipment is required to implant nitrogen.

The Vickers hardness Hv of the decorative product 1 where the austenite layer 22 is disposed is preferably 350 or higher, more preferably is 400 or higher, and yet even more preferably is 450 or higher. If the Vickers hardness Hv is below the lower limit of the range, it may be difficult to achieve mar resistance sufficient to the application of the decorative product 1.

The austenite layer 22 is provided over the entire surface of the base layer 2 in the arrangement shown in the figure, but the austenite layer 22 can be rendered on only a part of the base layer 2 surface.

The decorative product 1 can be any product with a decorative quality, and examples of a decorative product 1 include ornaments and other interior or exterior decorating goods, jewelry, external and internal timepiece parts, personal accessories, cigarette lighters and cases, rims for automobile tires, golf clubs and other sporting goods, name plates and panels, award cups, mechanical components including machine housings, and various types of containers. External timepiece parts include timepiece cases (such as the case member and back cover), timepiece bands (including band links, buckles, and other fasteners), dials, hands, bezels (including rotating bezels), crowns (including screw-lock crowns), buttons and other external operating members of a timepiece. Internal timepiece parts include the base plate of the movement, timepiece wheels and train wheel bridges, and rotary pendulums. Personal accessories include eyeglasses, necktie pins, cuff links, rings, necklaces, bracelets, anklets, broaches, pendants, earrings, and jewelry for body piercings. Of these, the decorative product of the present invention is particularly well suited to external parts for timepieces.

External timepiece parts are decorative and therefore require an attractive appearance but also require durability, corrosion resistance, mar resistance, dent resistance, wear resistance, and a pleasing texture for practical purposes, and the present invention enables satisfying all of these conditions. The present invention also affords a decorative product with excellent magnetic shielding, and when the decorative product of the present invention is used for external timepiece parts, the timepiece movement can be effectively protected from external magnetic fields.

Method of Manufacturing the Decorative Product

A preferred embodiment of a method of manufacturing the decorative product according to the present invention is described next.

FIGS. 2A and 2B are cross-sectional views schematically illustrating a method of manufacturing the decorative product according to a preferred embodiment of the present invention.

As shown in FIGS. 2A and 2B, the manufacturing method according to this aspect of the present invention has a base member preparation step, shown in FIG. 2A, to prepare the base layer 2, and an austenitizing step, shown in FIG. 2B, to form the austenite layer 22 near the surface of the base layer 2.

### Base Member Preparation Step

The base layer 2 is made primarily from an Fe—Cr alloy. The base layer 2 is usually shaped according to the decorative product 1 to be manufactured.

Fe—Cr alloys (the Fe—Cr alloy before nitrogen atoms are added) generally offer excellent moldability and therefore provide easily and reliably moldable base layers 2 that allow for complicated, detailed shapes that are preferred in external timepiece parts.

Surface processing, including mirror polishing, brushing, or satinizing, for example, of the base layer 2 used to manufacture the decorative product 1 is done before the austenitizing step. This allows varying the luster on the surface of the decorative product 1 and thus further improves the decorativeness of the decorative product 1. A mirror finish can be achieved using polishing methods known from the literature, including by way of buffing, barrel polishing, and other mechanical polishing methods.

### Austenitizing Step

As seen in FIG. 2B, the austenitizing is then done to the base layer 2. This forms the austenite layer 22 near the surface of the base layer 2 while leaving the base portion 21 exposed where the austenite layer 22 is not formed.

The austenitizing step can use various methods known from the literature, but the preferred method applies heat treatment in a nitrogen atmosphere followed by a quenching step. This effectively prevents problems such as surface roughening while efficiently creating the austenite layer 22.

The heat treatment process in this example raises the temperature of the chamber holding the base layer 2 at a constant rate and then holds a predetermined temperature (sustained temperature) T.

The rate of the temperature rise in the heat treatment process is not necessarily limited but is preferably 5-20° C./minute and is more preferably 5-15° C./minute. If the temperature rise is within the range, excessive expansion of the molding can be effectively prevented. If the temperature rise is below the lower limit of the range, the heat treatment process takes a long time, the molding easily expands, and the decorative product 1 production costs tend to rise. If the temperature rise exceeds the upper limit of the range, the load on the heat treatment equipment increases.

The sustained temperature T of the heat treatment process is not necessarily limited but is preferably 950-1300° C. and more preferably is 1000 to 1200° C. If the sustained temperature T is within the range, problems such as deformation and surface roughening of the base layer 2 can be effectively prevented while a desirable austenite layer 22 can be efficiently formed. If the sustained temperature T is below the lower limit of the range, the base layer 2 may not be sufficiently austenitized. If the sustained temperature T exceeds the upper limit of the range, it may be difficult to prevent deformation or surface roughening of the base layer 2, for example, and the aesthetic appearance of the decorative product may be impaired. The sustained temperature T can vary within the predetermined temperature range, in which case the maximum and minimum sustained temperatures T are preferably within the ranges defined above.

The holding time that the base layer 2 is held at or above 950° C. in the heat treatment process is preferably 3 to 48 hours, and more preferably is 10 to 30 hours. If the temperature holding time is within the range, problems such as deformation and surface roughening of the base layer 2 can be effectively prevented while a desirable austenite layer 22 can be efficiently formed. If the holding time is below the lower limit of the range, the base layer 2 may not be sufficiently austenitized. If the holding time exceeds the upper limit of the range, it may be difficult to prevent deformation or surface roughening of the base layer 2, for example, and the aesthetic appearance of the decorative product may be impaired. The productivity of the decorative product also drops if the holding time exceeds the upper limit of the range.

The cooling rate (such as the cooling rate when the temperature of the base layer 2 goes from the sustained temperature T to 100° C.) of the quenching process is not necessarily defined but is preferably 80° C./second or more, and is more preferably from 100-300° C./second. This results in a more homogenous austenite layer 22 with particularly high hardness, and affords a decorative product 1 with a particularly attractive appearance and excellent durability. If the cooling rate is below the lower limit of the range, the Cr in the base layer causes an unintended reaction with the nitrogen, and corrosion resistance drops.

### Timepiece

A timepiece according to the present invention having the decorative product of the present invention is described next below.

A timepiece according to the present invention includes the decorative product of the present invention as described above. As noted the decorative product of the present invention offers high hardness, excellent mar resistance, excellent dent resistance, and excellent corrosion resistance, and can maintain a particularly attractive appearance for a long period of time. The decorative product of the present invention more specifically provides both an excellent appearance and outstanding durability. The timepiece according to the present invention having this decorative product thus easily meets the conditions required in a timepiece. More specifically, the timepiece of the present invention retains a particularly attractive appearance for a long period of time. Other than the decorative product of the present invention, the parts of the timepiece of this invention are known from the literature, and one example of the arrangement of a timepiece according to the present invention is therefore described below.

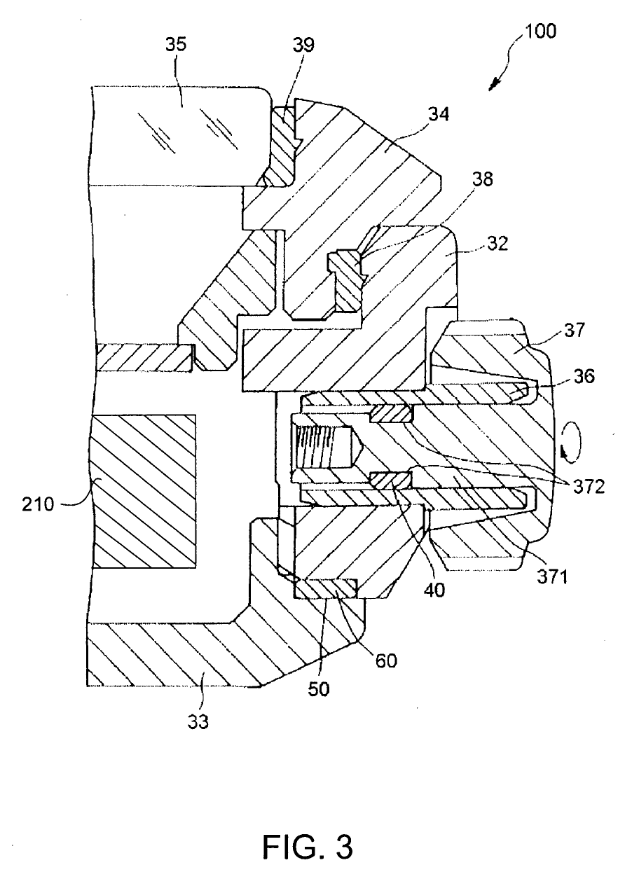

FIG. 3 is a partial cross-sectional view schematically describing a preferred embodiment of a timepiece (portable timepiece) according to the present invention.

As shown in FIG. 3 the wristwatch (portable timepiece) 100 according to this embodiment of the present invention has a case 32, a back cover 33, a bezel (ring) 34, and a crystal 35. A movement (drive unit) 210 such as an analog movement is held inside the case 32.

A stem pipe 36 is pressed into and fixed to the case 32, and the stem 371 of the crown 37 is inserted to rotate freely inside the stem pipe 36.

The case 32 and bezel 34 are joined with plastic packing 38, and the bezel 34 and the crystal 35 are fixed with plastic packing 39.

The back cover 33 is fit (or screwed) into the case 32, and a circular rubber packing (back cover seal) 60 is fit compressed into the joint (sealing portion) 50 between the case 32 and back cover 33. The sealing portion 50 thus seals the case against liquids and affords water resistance.

A channel 372 is formed around the middle of the outside of the stem 371 of the crown 37, and the circular rubber packing (crown seal) 40 is fit into this channel 372. This rubber crown packing 40 is tight to the inside wall of the stem pipe 36 and is compressed between this inside wall and the inside surface of the channel 372. The gap between the crown 37 and stem pipe 36 is thus sealed against liquids and water resistance is achieved. When the crown 37 is turned the rubber crown packing 40 turns with the stem 371 and slides circumferentially against the inside wall of the stem pipe 36.

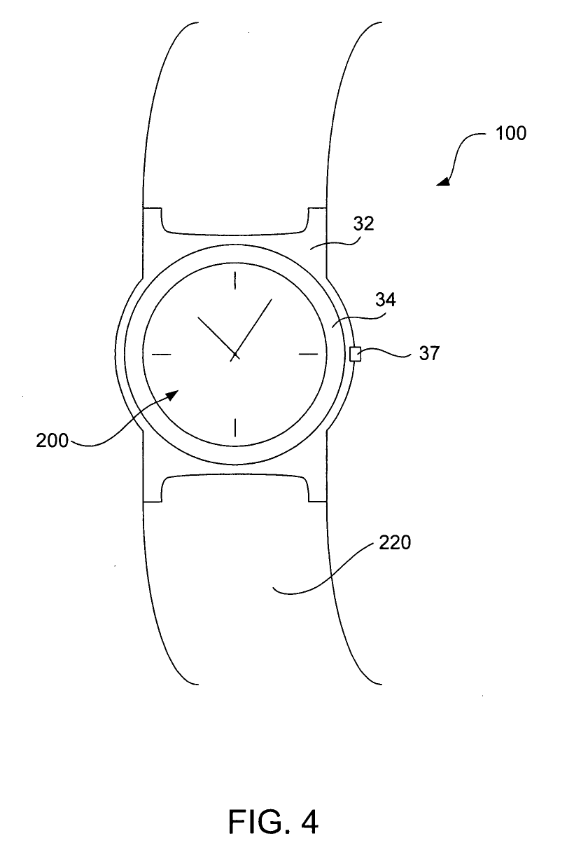

FIG. 4 is a plan view illustrating the timepiece (portable timepiece) 100 according to the preferred embodiment of the present invention.

As shown in FIG. 4 the wristwatch (portable timepiece) 100 according to this embodiment of the present invention has a case 32, a bezel (ring) 34, and a crown 37, and a time display 200. A movement (drive unit) 210 such as an analog movement is held inside the case 32. The time display 200 is connected to the movement 210 and shows time information.

In a wristwatch 100 according to the present invention at least one of the external decorative parts including the bezel 84, the case 82, the crown 87, the back cover 83, the watch band 220, or other decorative part is a decorative product according to the present invention.

The present invention is described above with reference to specific preferred embodiments thereof, but the present invention is not limited to these embodiments and can be varied in many ways.

For example, the base member in the above embodiments is described as being made primarily from an Fe—Cr alloy, but the present invention only requires that a portion near the surface of the base member (specifically near the surface to which the austenite layer is rendered) is primarily composed of an Fe—Cr alloy. The base member can be rendered, for example, with an Fe—Cr alloy surface layer disposed on the surface of a member composed of a non-metallic material or a metal material other than Fe—Cr alloy. In this case the thickness of the surface layer is preferably 500 μm or more.

The decorative product of the present invention is described above as having a base member including a base portion and an austenite layer, but a decorative product according to the present invention can be rendered with an arrangement other than the base member. For example, a coating having at least one layer can be rendered on the surface of the base member (austenite layer). This affords a decorative product with particularly outstanding characteristics including corrosion resistance, weather resistance, water resistance, oil resistance, mar resistance, dent resistance, wear resistance, discoloration resistance, rust resistance, stain resistance, and fogging resistance.

The decorative product of the present invention is also not limited to decorative products manufactured by the method described above.

Specific examples of the preferred embodiments of the present invention are described next.

### 1. Manufacturing of Decorative Product

### EXAMPLE 1

A decorative product according to the present invention was manufactured by the method described below to produce a wristwatch case (back cover) by way of example.

An Fe—Cr alloy primarily made of Fe was first prepared. This Fe—Cr alloy contains Fe, 18.3 wt % Cr, 2.25 wt % Mo, 0.15 wt % Nb, 0.26 wt % Mn, 0.006 wt % C, 0.001 wt % S, 0.022 wt % P, and 0.21 wt % Si, and is primarily ferrite phase. The content of other elements included as unavoidable impurities is less than 0.001 wt %.

This Fe—Cr alloy was then used to forge timepiece cases (back covers) to the desired shape, and the forging was then ground and polished as required.

The base member was then washed. The base member was washed in an alkaline electrolytic degreasing process for 30 seconds followed by an alkaline immersion degreasing process for 30 seconds, neutralizing for 10 seconds, a water wash for 10 seconds, and a demineralized water wash for 10 seconds.

An austenitizing process was then applied to form an austenite layer on the surface of the cleaned base member, resulting in the decorative product (wristwatch case (back cover)).

The austenitizing process was described next.

An austenitizing system having a process chamber surrounded by graphite fiber or other thermal insulation, a heating device to heat the process chamber, a depressurizing device to depressurize (venting) the process chamber, and a nitrogen supply device to introduce nitrogen to the process chamber was first prepared.

The base member was then placed in the process chamber of this austenitizing system, and the pressure inside the process chamber was lowered to 2 Pa by way of the depressurizing device.

The nitrogen supply device then introduced nitrogen to the process chamber at a rate of 2 liters/minute while the depressurizing device continued to vent the process chamber to maintain an internal pressure of 0.08 MPa to 0.12 MPa. The heating device then raised the internal temperature of the process chamber at the rate of 5° C./minute to 1200° C.

After holding the process chamber at 1200° C. for 12 hours, the base member was quenched to 30° C. with cold water. The cooling rate at which the base member was cooled from 1200° C. to 30° C. averaged 150° C./sec.

This process produced a decorative product (wristwatch case (back cover)) having an austenite layer that was austenitized by introducing nitrogen atoms near the surface of the base member. The thickness of the resulting austenite layer was 350 μm. The nitrogen content of the austenite layer was 0.9 wt %.

### EXAMPLES 2 TO 7

The decorative products (wristwatch cases (back covers)) in these examples were manufactured in the same way as the decorative product in the first example except that the composition of the Fe—Cr alloy used to mold the base member (the substrate used to manufacture the decorative product) and the conditions of the austenitizing process were varied as shown in Table 1.

### Comparison 1

A decorative product was manufactured in the same way as the decorative product in the first example except that the austenitizing process was not applied. More specifically, the decorative product used as this comparison was the base member resulting from the forging process.

### Comparison 2

A decorative product (wristwatch case (back cover)) was manufactured by the following method.

A metal powder of ferritic stainless steel (a powder of primarily Fe but containing Fe, 21.63 wt % Cr, 2.28 wt % Mo, 0.12 wt % Nb, 0.06 wt % S, 0.45 wt % Mn, 0.8 wt % Si, 0.018 wt % P, and 0.04 wt % C) was prepared. The average grain size of this metal powder was 10 μm.

A mixture containing 75 vol % metal powder, 8 vol % polyethylene, 7 vol % polypropylene, and 10 vol % paraffin wax was then kneaded using a kneader. The material temperature during kneading was 60° C.

The kneaded mixture was then ground and graded to get pellets with an average diameter of 3 mm. These pellets were then used to produce moldings in the shape of a wristwatch case (back cover) by way of metal injection molding (MIM) using an injection molding machine. The moldings were made to allow for shrinkage during debindering and sintering. The injection molding conditions were a 40° C. mold temperature, 80 kgf/cm² injection pressure, 20 second injection period, and 40 second cooling period.

The resulting molding was then passed through a debindering process using a degreasing oven to get a degreased molding. This debindering process held the molding in a 1.0×10⁻¹ Pa argon atmosphere at 80° C. for 1 hour, and then increased the temperature to 400° C. at a rate of 10° C./hour. Sample weight was measured during heat treatment, and debindering ended when weight loss stopped.

The degreased molding was then sintered using a sintering oven to complete the base member. Sintering was done in a 1.3×10⁻³ to 1.3×10⁻⁴ Pa argon gas atmosphere at 900° C. to 1100° C. for 6 hours.

The resulting base member was then ground and polished as required to finish the decorative product (wristwatch case (back cover)).

### Comparison 3

A decorative product (wristwatch case (back cover)) was manufactured by the following method.

A metal powder of ferritic stainless steel (a powder of primarily Fe but containing Fe, 18 wt % Cr, 2.5 wt % Mo, 0.03 wt % S, 2 wt % Mn, 0.8 wt % Si, 0.04 wt % P, 0.03 wt % C, and 15 wt % Ni) was prepared. The average grain size of this metal powder was 10 μm.

A mixture containing 75 vol % metal powder, 8 vol % polyethylene, 7 vol % polypropylene, and 10 vol % paraffin wax was then kneaded using a kneader. The material temperature during kneading was 60° C.

The kneaded mixture was then ground and graded to get pellets with an average diameter of 3 mm. These pellets were then used to produce moldings in the shape of a wristwatch case (back cover) by way of metal injection molding (MIM) using an injection molding machine. The moldings were made to allow for shrinkage during debindering and sintering. The injection molding conditions were a 40° C. mold temperature, 80 kgf/cm² injection pressure, 20 second injection period, and 40 second cooling period.

The resulting molding was then passed through a debindering process using a degreasing oven to get a degreased molding. This debindering process held the molding in a 1.0×10⁻¹ Pa argon atmosphere at 80° C. for 1 hour, and then increased the temperature to 400° C. at a rate of 110° C./hour. Sample weight was measured during heat treatment, and debindering ended when weight loss stopped.

The degreased molding was then sintered using a sintering oven to complete the base member. Sintering was done in a 1.3×10⁻³ to 1.3×10⁻⁴ Pa argon gas atmosphere at 900° C. to 1100° C. for 6 hours.

The resulting base member was then ground and polished as required to finish the decorative product (wristwatch case (back cover)).

The composition of the base member used to manufacture the decorative products, the austenitizing conditions, and the austenite layer conditions for each of the preferred embodiments and comparison samples are shown in Table 1.

TABLE 1

| | | | | | | | | | | Austenitizing conditions | | | | Austenite layer | |
|---|---|---|---|---|---|---|---|---|---|---|---|---|---|---|---|
| | | | | | | | | | | Heating | Sustained | Time | Cooling | Thick- | Ni |
| | Content (wt %) | | | | | | | | | (° C./ | temp. | >1000° C. | (° C./ | ness | content |
| | Cr | Mo | Nb | Mn | C | S | P | Si | Ni | min) | (° C.) | (hrs) | sec) | (μm) | (wt %) |
| Ex. 1 | 18.3 | 2.25 | 0.15 | 0.26 | 0.006 | 0.001 | 0.022 | 0.21 | 0.01 | 5 | 1200 | 12 | 150 | 350 | 0.9 |
| Ex. 2 | 25 | 2 | 0.15 | 0.2 | 0.006 | 0.001 | 0.022 | 0.21 | 0.05 | 5 | 1200 | 12 | 150 | 350 | 1.2 |
| Ex. 3 | 17 | 2 | 0.15 | 0.2 | 0.006 | 0.001 | 0.022 | 0.21 | 0.01 | 5 | 1200 | 12 | 150 | 350 | 0.9 |
| Ex. 4 | 18 | 1 | 0.15 | 0.2 | 0.006 | 0.001 | 0.022 | 0.21 | 0.01 | 10 | 1100 | 4 | 30 | 100 | 0.9 |
| Ex. 5 | 19 | 3 | 0.15 | 0.2 | 0.006 | 0.001 | 0.022 | 0.21 | 0.01 | 8 | 1250 | 30 | 120 | 500 | 0.9 |
| Ex. 6 | 18.3 | 2.5 | 0.15 | 0.26 | 0.006 | 0.001 | 0.022 | 0.21 | 0.01 | 5 | 1200 | 0.5 | 150 | 5 | 0.9 |
| Ex. 7 | 17 | 2 | 0.1 | 0.2 | 0.006 | 0.001 | 0.022 | 0.21 | 0.01 | 5 | 1200 | 12 | 150 | 350 | 0.3 |
| Comp. 1 | 18.5 | 2.25 | 0.15 | 0.26 | 0.006 | 0.001 | 0.022 | 0.21 | 0.01 | | | | | | |
| Comp. 2 | 21.63 | 2.28 | 0.12 | 0.45 | 0.04 | 0.06 | 0.018 | 0.8 | 0.01 | | | | | | |
| Comp. 3 | 18 | 25 | | 2 | 0.03 | 0.03 | 0.04 | 0.8 | 15 | | | | | | |

### 2. Visual Evaluation of Appearance

The decorative products manufactured in each of the preferred embodiments and comparison samples described above were visually and microscopically inspected and then ranked according to the following four levels.

VG: very good appearance

G: good appearance

OK: acceptable appearance

x: unacceptable appearance

### 3. Evaluation of Surface Layer Mar Resistance

The mar resistance of each of the preferred embodiments and comparison samples described above was evaluated using the following test method.

A brass bristle brush was pressed and slid bidirectionally against the surface of the decorative product 50 times. The load pressing the brush to the surface was 0.2 kgf.

The surface of the decorative product was then visually inspected and the appearance was ranked according to the following four levels.

VG: no observable surface scratches

G: substantially no observable surface scratches

OK: slight surface scratching observable

x: significant surface scratching observable

### 4. Dent Resistance Evaluation

The dent resistance of each of the preferred embodiments and comparison samples described above was evaluated using the following test method.

A stainless steel ball (1 cm diameter) was dropped from a height of 50 cm above the decorative product, the size (diameter) of the indentation left in the decorative product surface was measured, and the results were ranked according to the following four levels.

VG: dent diameter<1 mm or no observable dents

G: 1 mm<=dent diameter<2 mm

OK: 2 mm<=dent diameter<3 mm

x: dent diameter>=3 mm

### 5. Corrosion Resistance Evaluation

The corrosion resistance of each of the preferred embodiments and comparison samples described above was evaluated by measuring the pitting potential according to the method described in JIS G 0577, the higher the pitting potential, the greater the corrosion resistance.

### 6. Magnetic Shielding (Magnetic Resistance) Evaluation

The magnetic shielding (magnetic resistance) of each of the preferred embodiments and comparison samples described above was evaluated using the following test method.

The decorative product samples manufactured in each of the preferred embodiments and comparison samples described above were stamped in the middle through the thickness of the decorative product to remove a blank. The blank was then ground at 30° C. and loaded into a gelatin capsule. The magnetization of each capsule was then measured using a magnetometer (MPMS-5S SQUID, Quantum Design) to get a hysteresis curve. Magnetization was measured at 37° C. in a magnetic field ranging from −1000 G to 1000 G (approximately −80,000 m/A to 80,000 m/A). The slope of the hysteresis curve near a field strength of 0 was measured to determine permeability. Magnetic shielding improves as permeability rises.

The results of these measurements are shown in Table 2 together with Vickers hardness Hv measurements. The Vickers hardness Hv measurements indicate the results using a 20 gf measurement load at the surface of each sample (where the austenite layer was formed).

TABLE 2

| | Appear- | Mar | Dent | Corrosion | Magnetic |
|---|---|---|---|---|---|
| | ance | resistance | resistance | resistance | shielding |
| Example 1 | VG | VG | VG | VG | VG |
| Example 2 | VG | VG | VG | VG | G |
| Example 3 | VG | VG | VG | G | VG |
| Example 4 | VG | VG | G | G | VG |
| Example 5 | G | VG | VG | VG | G |
| Example 6 | VG | G | G | G | VG |
| Example 7 | VG | G | G | G | VG |
| Comparison 1 | G | X | X | X | G |
| Comparison 2 | X | VG | VG | X | G |
| Comparison 3 | X | VG | VG | X | X |

As will be known from Table 2 the decorative product according to the present invention offers a particularly attractive appearance as well as excellent mar resistance, dent resistance, and corrosion resistance. As a result, a decorative product according to the present invention can retain its particularly attractive appearance for a long period of time. The decorative product of the present invention also offers excellent magnetic shielding. The decorative product of the present invention also offers an outstanding texture with no surface roughness. The decorative product according to the present invention is thus well suited to use as an external part of a timepiece.

In contrast, the decorative products in each of the comparison samples did not provide satisfactory results.

The present invention being thus described, it will be apparent from this disclosure that it may be varied in many ways. Such variations are not to be regarded as a departure from the spirit and scope of the present invention, and all such modifications as would be apparent to one skilled in the art are intended to be included within the scope of the following claims.

In addition, the preferred configurations, methods, and other aspects for carrying out the present invention are disclosed in the above descriptions, but the present invention is not limited thereto. Specifically, the present invention is particularly illustrated and described primarily with reference to specific embodiments, but those skilled in the art can make various modifications to the shapes, materials, quantities, and other specific details of the embodiments described above without deviating from the scope of the technical ideas and objects of the present invention.

The terms “front,” “back, “up,” “down,” “vertical,” “horizontal,” “slanted,” and other direction-related terms used above indicate the directions in the diagrams used. Therefore, the direction-related terminology used to describe the present invention should be interpreted in relative terms as applied to the diagrams used.

“Substantially,” “essentially,” “about,” “approximately,” and other terms that are used above and represent an approximation indicate a reasonable amount of deviation that does not bring about a considerable change as a result. Terms that represent these approximations should be interpreted so as to include a minimum error of about ±5%, as long as there is no considerable change due to the deviation.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A decorative member, comprising:
a base member having
an austenite layer austenitized and primarily made of an Fe—Cr alloy, and
a base portion primarily made of an Fe—Cr alloy.

2. The decorative member according to claim 1, wherein
a thickness of the austenite layer is 5 μm to 500 μm.

3. The decorative member according to claim 2, wherein
the thickness of the austenite layer is 150 μm to 350 μm.

4. The decorative member according to claim 1, wherein
nitrogen content in the austenite layer is 0.3 wt % to 1.2 wt %.

5. The decorative member according to claim 4, wherein
nitrogen content in the austenite layer is 0.8 wt % to 1.2 wt %.

6. The decorative member according to claim 1, wherein
Ni content in the base member is less than or equal to 0.05 wt %.

7. The decorative member according to claim 1, wherein
the base member is further made of one of the group consisting Mo, Nb, Mn, Si, Zr and Ti.

8. The decorative member according to claim 1, wherein
the austenite layer has a Vickers hardness Hv of 350 or higher.

9. The decorative member according to claim 8, wherein
the austenite layer has a Vickers hardness Hv of 400 or higher.

10. The decorative article member according to claim 1, wherein
a thickness of the austenite layer is 150 μm to 350 μm,
nitrogen content in the austenite layer is 0.8 wt % to 1.2 wt %,
Ni content in the base member is less than or equal to 0.05 wt %,
the base member is further made of one of the group consisting Mo, Nb, Mn, Si, Zr and Ti, and
the austenite layer has a Vickers hardness Hv of 400 or higher.

11. A timepiece, comprising:
a drive unit;
a time display being connected to the drive unit and displaying time information; and
a case housing the drive unit and the time display, the case having;
a base member having
an austenite layer austenitized and primarily made of an Fe—Cr alloy, and
a base portion primarily made of an Fe—Cr alloy.

12. The timepiece according to claim 11, further comprising
an external part connected to the case, the external part having
a base member having
an austenite layer austenitized and primarily made of an Fe—Cr alloy, and
a base portion primarily made of an Fe—Cr alloy.

13. The timepiece according to claim 12, wherein
the external part is one of the group consisting a bezel, crown, back cover, and a band.

14. The timepiece according to claim 11, wherein
a thickness of the austenite layer is 5 μm to 500 μm.

15. The timepiece according to claim 11, wherein
nitrogen content in the austenite layer is 0.3 wt % to 1.2 wt %.

16. The timepiece according to claim 11, wherein
Ni content in the base member is less than or equal to 0.05 wt %.

17. The timepiece according to claim 11, wherein
the base member is further made of one of the group consisting Mo, Nb, Mn, Si, Zr and Ti.

18. A method for making a decorative product, comprising:
preparing a base member primarily made of an Fe—Cr alloy;
washing the base member;
depressurizing a surrounding area of the base member;
introducing nitrogen to the area to austenitize the base member; and
heating the area to a first temperature of 1200° C.

19. The method of making a decorative product according to claim 18, further comprising,
holding the first temperature for 12 hours, and
quenching the base member to a second temperature of 30° C.
